(19) United States
(12) Patent Application Publication
(10) Pub. No.: US 2001/0018140 A1
(43) Pub. Date: Aug. 30, 2001

(54) Catalytic burner element inside a fuel cell with structured catalytic coated surfaces

(76) Inventors: Ingo Hermann, Mainz (DE); Hans-Gerd Dusterwald, Mainz (DE)

Correspondence Address: LAWRENCE B. PLANT, General Motors Corporation, Legal Staff, Mail Code 482-C23-B21, P.O. Box 300, Detroit, MI, 48265-3000, US

(21) Appl. No.: 09/778,031

(22) Filed: Feb. 6, 2001

(30) Foreign Application Priority Data
Feb. 20, 2000 (DE) 100 07 764.1

(51) Int. Cl. H01M 8/18

(52) U.S. Cl. 429/20

(57) ABSTRACT

A heat-emitting burner element, especially for use in a reformer unit of a fuel cell system, consists of two at least essentially parallel and spaced-apart plates and is characterized by the fact that the plates form a reaction gap between them, and as a result of the catalytic combustion of a fuel gas/oxygen mixture there on a catalytic coating facing the reaction gap provided on at least one of the plates, generate heat and emit it by radiation, convection and conduction directly through the coated plates(s) to at least one neighboring endothermic stage and that at least one of the plates displays structural elements having the catalytic coating and also extending into the reaction gap, which structural elements extend in the flow direction and consist, e.g., of fins or bars. A device for introducing diluting air transversely to the flow direction through the reaction gap is preferably provided.

### TECHNICAL FIELD

The present invention concerns a heat-emitting burner element for use with at least one processing device of a fuel cell system carrying out an endothermic process, e.g., with an endothermic stage of a reforming unit, said burner element consisting of at least two at least essentially parallel plates arranged at a distance from each other and a process for controlling the endothermic reforming reaction in a fuel-processing system generating a hydrogen-rich synthetic gas which contains at least one such burner element.

### BACKGROUND OF THE INVENTION

Fuel cell systems require the energy carrier hydrogen for the generation of current. This hydrogen is frequently generated by an endothermic conversion process from liquid energy carriers such as methanol with introduced water, ethanol, methane and higher hydrocarbons such as gasoline, naphtha, DME, natural gas, kerosene and synthetic fuels, e.g., diesel oil. The necessary process heat is supplied by exothermic reactions which are coupled into the process mode. The combination of a heat-generating and hydrogen-producing unit is ordinarily called a “fuel processor”, i.e. a fuel preparation system.

The present invention is based on a layered structure of a fuel processor system in which flat structures of different functionality are stacked one above the other in space and coupled to each other in accordance with their technical tasks. In such a fuel processor system the zones, for example, catalytic combustion, reforming and water-gas shift alternate with each other. A strongly endothermic reaction stage such as reformation must necessarily be surrounded on both sides by heat-supplying combustion stages.

A fuel processor of the type described initially is disclosed in the European preliminary published application EP 0 861 802 A2.

In the known device, a reforming unit is present between catalytically acting burner elements. In all layers of the known fuel processor with catalysts, said catalysts are present in the form of pellets and are fixed in loose layers on the corresponding stages. This system has a number of disadvantages: (1) the fixation of the loose pellets in space in order to assure functionality; (2) mechanical abrasion of the pellets and loss of catalytic activity as a result of vibration and the mobile use of the fuel processor; and (3) heat and mass transfer inhibition of catalytic reactions in the loose bed.

The reformation reaction is extremely influenced by the heat balance. For high yields, a homogeneous temperature distribution in the reaction layer is necessary. This does not exist in the case of pellets in the loose bed since a certain empty space volume is always present. This results in a lower yield per reaction volume and therefore per catalyst unit mass, entailing a higher catalyst quantity for complete conversion. The consequences are a larger structural volume and weight as well as high costs.

The catalytic combustion reaction on pellets is also limited by heat and mass transfer. In particular, the produced heat must be transferred efficiently to the neighboring zones, and this is also difficult in the case of loose layers; it has been attempted to alleviate this shortcoming by constructive measures such as heat-transferring fins.

The regulation of the heat balance, especially in the case of dynamic operation of such a fuel processor, is also an unresolved problem. The heat must be available wherever it is required by the endothermic reaction steps. A heat deficit or a heat surplus interfere with the reaction and lead to functioning failures or damage to the equipment.

### SUMMARY OF THE INVENTION

The purpose of the invention is to avoid the above-described disadvantages and to devise a burner element which, in a compact design, achieves a high heat output per reaction volume unit with efficient transfer of heat to the neighboring heat absorbing elements of the fuel processor as well as efficient heat and mass transfer, in which case the burner element should be designed in such a way that an efficient control of the catalytic combustion reaction can be achieved. Another objective of the invention is to devise a process for controlling the exothermic combustion process in a burner element and therefore also to control the endothermic reformation reactions in a reforming unit adjacent to the burner element.

A first solution o these problems according to the invention with a burner element of the type described initially is characterized by the fact that the plates form a reaction gap between themselves and generate heat as a result of the catalytic combustion of a fuel gas/oxygen mixture there on a catalytic coating provided on at least one of the plates and facing toward the reaction gap and transfer it by radiation, convection and conduction directly through the coated plate(s) to at least one neighboring exothermic stage and that at least one of the plates extending into the reaction gap also displays structural elements displaying catalytic coatings which run in the flow direction, which structural elements are possibly in rows which are arranged transversely to the direction of flow and may be offset from each other and consist, for example, of fins or bars.

Through the use of plates displaying catalyst-coated structural elements instead of catalysts in pellet form, it is possible to achieve a very large ratio of surface to volume and smaller reaction volumes, thus realizing a very efficient heat and mass transfer. Because the catalyst is applied directly to the plates of the burner element, heat generated in the burner element is passed on directly to the side of the plates facing the reaction gap and directly through the plate to the neighboring heat-absorbing elements. Therefore the heat transfer from the catalyst to the plate of the burner element is much more efficiently configured.

The structural elements of the plates according to the invention can also be realized by designing the plates forming the reaction gap to be wavelike or corrugated, in which case the longitudinal direction of the peaks and valleys forming the waves runs in the flow direction of the combustible gases.

The use of corrugated plates in a reactor for catalytic treatment of gaseous fluids is known from DE-OS 42 14 579 A1. Here, however, the waves of the plates run perpendicular to the flow direction so that, on the one hand, the arrangement is not of space-saving design, and on the other, the flow resistance is increased. In addition, the known arrangement is not used for a fuel processor but rather for the purification of exhaust air. For this purpose the countercurrent principle is used there with which the same medium flows in neighboring flow channels in opposite directions so that the reaction heat of one stream leads to a heating of the opposing stream.

Because the structural elements displaying the catalytic coating extending into the reaction gap according to the invention also run in the flow direction of the combustible gas through the burner element, the surface supporting the catalyst material can be enlarged without generating an unacceptable resistance for the fuel gas/oxygen mixture flowing through the reaction gap.

Due to the fact that the fuel gas/oxygen mixture flows from the inlet on one side of a four-sided element to the outlet on the opposite side of the element, the possibility exists of introducing diluting air into the mixture on one or both of the two remaining sides, e.g. by providing a device for introducing diluting air transversely to the direction of flow in at least one and preferably in several places along at least one of the also opposite third and fourth sides of the element so that control of the catalytic reaction is made possible.

Such a control of the catalytic reaction is desirable according to the invention in order to match the heat consumption and production to each other. Too low temperatures on the reforming side inhibit the reaction, while too high temperatures excessively accelerate the reforming reaction, disturb the uniform course of the coupled reactions and may locally lead to strong thermal imbalances. This may lead to intensified catalyst aging. The catalytic oxidation reaction therefore is preferably controlled by the introduction of air perpendicular to the flow direction of the fuel gas.

The quantity of air is controlled by the pressure loss of the inlet openings over the running length. The dilution with air reduces the rate of the catalytic reaction, less heat is liberated and the heat can be managed selectively. Air can therefore be metered in a controlled way over the entire length or width of the catalytic combustion zone.

It is especially favorable to provide the sides of the plates of the burner element facing away from the reaction gap also with a catalyst material which is necessary for the work of reforming. This arrangement especially utilizes the basic idea of the invention, i.e. to couple the heat source and the heat sink directly in space in order to generate the heat where it is consumed. The plates of the burner element are therefor utilized to generate a direct coupling between reforming and catalytic combustion. Each plate functions as a separating layer on one side of which the oxidation catalyst of the burner element and on the other side the reforming catalyst are present.

The heat transfer takes places by radiation, convection and conduction directly through the separating layer. This separating layer may be either planar or structured. The basic idea of this compact, efficient “sandwich” concept is the switchover from pellet catalyst to coated surfaces.

As a result of the design of the burner element according to the invention, it is possible to provide an alternating sequence of burner elements and reforming units which follow one another directly so that an extremely compact and highly efficient structure is achieved. Since the heat conduction is efficient, uniform temperatures can be achieved in the entire structure so that the reactions always take place under precisely defined temperature conditions and premature failure of the fuel processor due to local overheating can essentially be avoided

In process terms, the present invention therefore envisages a process for controlling the endothermic reformation reaction in a fuel processing system generating a hydrogen-rich synthetic gas containing at least one burner element in which a fuel/oxygen mixture is introduced into a slot-like reaction chamber, the process being characterized by the fact that it is controlled at least partially by controlling the quantity of diluting air introduced into the burner element.

A second solution to the problems posed above according to the invention is for the plates to form a reaction gap between them and as a result to the catalytic combustion of a fuel gas/oxygen mixture there, heat is generated on a catalytic coating facing the reaction gap provided on at least one of the plates and the heat is transferred by radiation, convection and conduction directly through the coated plate(s) to at least one neighboring endothermic stage, that the element in top view is at lest essentially four-sided, e.g. square, rectangular or trapezoidal, that the reaction gap is divided at least by one separating wall into at lest two parallel running slot-like reaction chambers and that the one reaction chamber on a first side of the four-sided element displays an inlet for the one component of the fuel gas/oxygen mixture, while the second reaction chamber on the same side displays an inlet for another component of the fuel gas/oxygen mixture, openings being provided in the or in each separating wall and designed in order to make an exchange of gases possible in each of the reaction chambers or to promote a diffusion equalization while it flows from the inlets to the outlet on a second side opposite the first side.

In this burner element the combustible gas is preferably introduced into the first slot-like reaction chamber and air is preferably introduced into the second slot-like reaction chamber. Here also the plates extending into the reaction gap may also display structural elements having catalytic coatings which extend in the direction of flow and consist, e.g., of fins or bars. The structural elements may also be designed by making the plates forming the reaction gap waved, in which case the longitudinal direction of the peaks and valleys forming the waves extends in the flow direction of the combustible gases. Because the two components of the fuel gas/oxygen mixture flow over both sides of the separating wall and this flow is disturbed because of the openings present in the separating wall and the structural elements, diffusion processes occur from both sides of the separating wall so that the two above-mentioned components o the fuel gas/oxygen mixture are mixed on both sides of the separating wall and react chemically with each other there with the aid of the catalytic coatings and generated heat. Since this diffusion equalization or mixing of the two components takes place over the entire length of the separating wall, the chemical reaction also takes place over the entire length of the reaction chambers and transversely to the separating wall so that a uniform production of heat results and the burner element does not suffer the disadvantage that too much heat is generated at one place, while little heat arises in other regions. This means that the design according to the invention leads to an essentially more uniform temperature distribution over the entire area of the burner element, and this is beneficial for the endothermic process which is conducted on the outside of the one or both plates and utilizes the heat emitted by the burner element.

Because the separating wall is realized as an extremely thin part, preferably of perforated sheet metal, it occupies little space so that a very compact design of the burner element is attained.

At this point it should be mentioned that a mixed composition deviating from the stoichiometrically ideal composition during the catalytic transformation of a fuel gas/oxygen mixture into heat does not lead to the formation of soot or to other undesired deposits, because only as much of each component is reacted as can react chemically with the other and the unconsumed constituents are removed with the exhaust gases on the outlet side and may if necessary be fed to another burner element or used for other purposes. Since the separating wall assures an increasing mixing of the two components over the entire length and width of the burner element, on the one hand, the desired uniform temperature distribution is created. This property is responsible on the other hand for the fact that by controlling the total quantity of fuel gas/oxygen mixture fed in, a power-related adaptation of the heat generated in the burner element and of the heat made available to the neighboring endothermic processing steps is achieved so that the process can be governed as a whole, and for example, in this way an adaptation to different load cycles can be achieved.

The invention also concerns a catalyst-coated plate for a heat-emitting burner element which consists of two plates arranged essentially parallel to each other and at a distance apart with the special characteristics that the plate in top view is essentially four-sided, for example, square, rectangular or trapezoidal, that on the first and second opposite sides of the four-sided element in each case an inlet zone and an outlet zone are provided and that the plate displays on the above mentioned surface covered with catalyst structural elements extending in the flow direction consisting, for example, of fins or bars.

Especially preferred variants of the burner element of the invention and of the plate in the process for controlling the endothermic reformation reactions in a fuel-processing system can be derived from the claims and the further description.

### BRIEF DESCRIPTION OF THE DRAWINGS

The invention will now be explained in detail with reference to examples and the drawings in which:

FIG. 1 shows the layered structure of a fuel-processing system according to the invention with different layers of alternating functionality, in which the structure shown can continue, for example, according to the broken arrow I;

FIG. 2 is a top view of a planar burner element corresponding to the invention with gas and air feed lines;

FIG. 3 is a cross section corresponding to sectional plane III-III in FIG. 2;

FIG. 4 is a possible configuration of the one plate of the burner element in FIGS. 2 and 3 in the region of the boundary surface with the neighboring reforming unit;

FIG. 5 shows a schematic representation in order to explain possible structuring of the sides of the burner element according to the invention facing the reaction gap;

FIG. 6 is a top view corresponding to FIG. 2 of a burner element divided into three sections with a diluting air supply;

FIG. 7 is a cross section to the burner element in FIG. 6 corresponding to sectional plane VII-VII;

FIGS. 8A and 8B shows diagrams explaining the temperature curve in a burner element without the side feed of diluting air and with such a side feed as shown in FIG. 7;

FIG. 9 is a perspective schematic representation of a segment of a burner element according to the invention;

FIG. 10 is a top view of the plate for a burner element according to the invention;

FIG. 11 is an enlarged representation of the structural elements with the plate in FIG. 10 corresponding to the region XI shown there; and

FIG. 12 is an alternative design of a burner element according to the invention with a sectional representation similar to that in FIGS. 3 and 7.

### DESCRIPTION OF THE PREFERRED EMBODIMENT

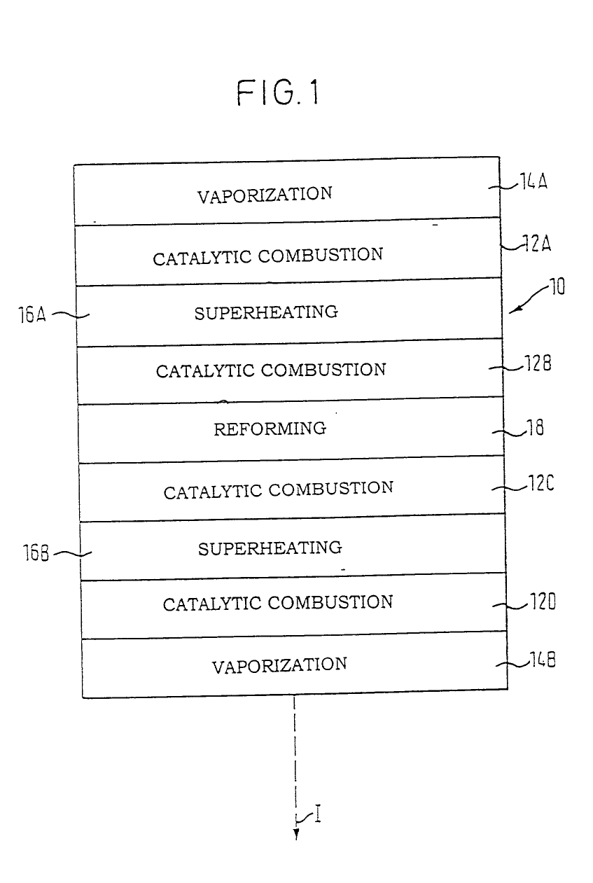

FIG. 1 shows in purely schematic form the alternating layers of a fuel processing system 10 in order to represent the possible application of the catalytic burner element 12 according to the invention.

For example, as disclosed in European preliminary published application EP 0 920 064 A1, a fuel processing device for fuel cells has the purpose of transforming a fuel consisting of a hydrocarbon, usually in the form of CH₃OH, into a hydrogen-rich synthetic gas which is supplied to the actual fuel cell arrangement for generating current. For this purpose, methanol together with water, is fed into the fuel processing system 10 and preheated by heat exchange with the reform gases or exhaust gases of the system. Then the methanol/water mixture is evaporated in an evaporation stage, here denoted by 14A. The heat necessary for this evaporation is generated by a first burner element 12A according to the invention which is adjacent to one side of the evaporation device 14A. On the side of the burner element 12A facing away from the evaporation device 14A is a so-called superheating device 16A which has the purpose of heating the fuel/oxygen mixture (oxygen usually fed in as air) already transformed into vapor in the evaporation unit 14A to circa 300° C. The corresponding superheating unit 16A receives heat not only from the first burner element 12A shown in FIG. 1 at the top but also from a second burner element 12B which is arranged below the superheating unit 16A in FIG. 1.

In the schematic representation in FIG. 1, two additional burner elements 12C and 12D are shown, a reforming unit 18 being arranged between the two central burner elements 12C and 12B in FIG. 1 which transforms the methanol/water mixture heated in the superheating unit 16A into a hydrogen-rich synthetic gas which consists predominantly of H₂ and CO₂ but also contains N₂, CO and water. The reforming unit 18 thus receives heat from both sides, from the burner elements 12B and 12C. Below the burner elements 12C is another superheating unit 16B which is positioned between the burner element 12C according to the invention and the other burner element 12D according to the invention. Below the bottom burner element 12D in FIG. 1 again is another evaporation unit. The incoming methanol/water mixture is accordingly fed to both evaporation units 14A and 14B by corresponding feed lines which are formed in the stacked units in FIG. 1. The mixture preheated in the evaporation units 14A and 14B is accordingly supplied also to the two superheating units 16A and 16B whose outgoing streams are fed to the reforming unit 18.

FIG. 1 shows no gas and liquid feed or removal lines, but such lines are realized at least partially by corresponding passage ducts inside the fuel processing system 10 in FIG. 1 which is composed of planar elements. Such passage ducts are well know, e.g., from the above mentioned document EP-A 0 861 802.

The arrow I indicates that the basic structure shown in FIG. 1 can be repeated, which is usually the case. The possibility of repeating the structural units has the special advantage that a modular structure is achieved which can be adapted by the corresponding choice of the total number of units present to any power requirement which may arise. Therefore, the units shown schematically in FIG. 1 can be produced economically. At this point it should be emphasized that the sequence of units shown in FIG. 1 is not compulsory. Other sequences are also possible such as the sequences shown in EP-A 0 861 802. The possibility also exists of supplying the methanol and water separately to the fuel processing device and treating them selectively in each case before they are supplied to the reforming unit(s). Otherwise the stack 10 shown in FIG. 1 is not absolutely complete. Other units may be provided such as so-called hydrogen shift units and units for transforming carbon monoxide into carbon dioxide.

The central point of the present invention, however, is not the overall design of the fuel processing system, but rather the design of the burner elements 12A-D which can be utilized in such a fuel processing device.

Within the scope of the present description, several examples will now be discussed for the burner element 12 according to the invention to carry out the catalytic combustion inside such a compact processing system with a flat catalyst coating.

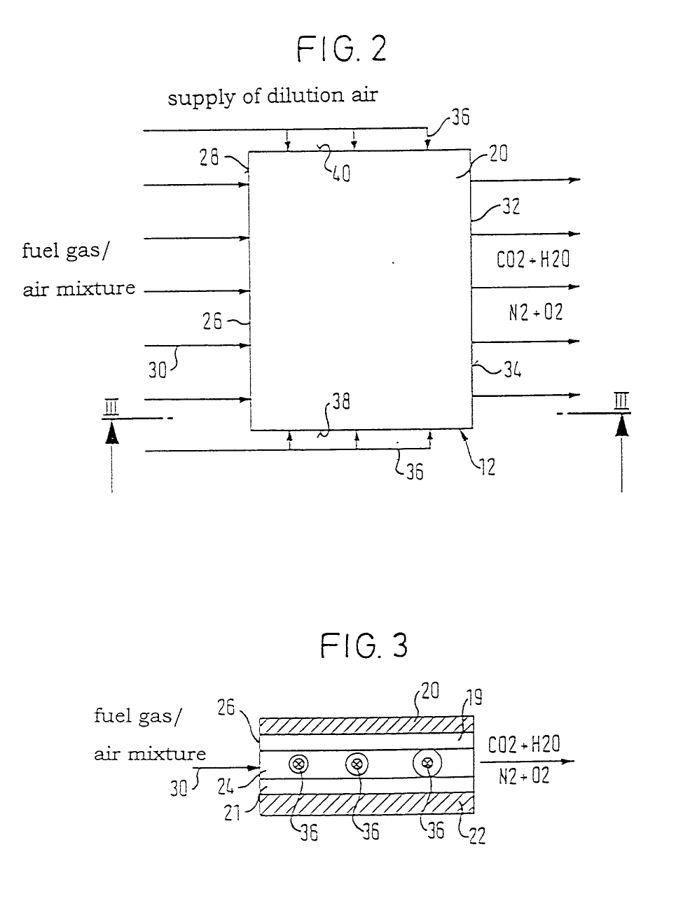

The burner element 12 in FIGS. 2 and 3 consists of two flat metal plates 20, 22 lying one above the other, e.g., made of stainless steel, which form a reaction gap 24 between them. Both surfaces of the plates 20, 22 facing toward the reaction gap 24 are coated with a defined quantity of an oxidation catalyst such as platinum or palladium. The known catalyst coating processes are optimized to such an extent that a defined film thickness can be maintained.

According to FIGS. 2 and 3, the fuel gas/oxygen mixture flows into the reaction gap at the inlet 26 to a first side 28. Regarding this it may be said that the representations shown in FIGS. 2 and 3 are very schematic in this respect. In its practical version the fuel gas/air mixture is fed through a channel in the reaction gap which stands perpendicular to the plane in FIG. 2 and which is provided in the edge region of the first side 28, as will be explained in more detail below. The flow in the reaction gap is axial (in the direction of arrow 30). The completely reacted exhaust gases consisting of H₂ and CO₂ but also of N₂, CO and H₂O emerge at the outlet 32 on the second side 34 of the burner element 12 lying opposite the inlet side 28. Here also FIGS. 2 and 3 are to be understood schematically. In a specific variant, the exhaust gases from the burner element are carried away by channels formed inside the stack.

The heterogeneous catalyzed combustion reactions of the fuel gas/air mixture take place on the surface of the catalyst. The heat supplied to the neighboring zones is absorbed by the endothermic processes, which the evaporation units 14A, 14B, the superheating units 16A and 16B and the reforming unit 18 of FIG. 1 represent, by convection, conduction and radiation.

Control of the catalytic reaction is absolutely necessary in order to be able to match the local heat consumption and production to each other. Too low temperatures on the reforming side inhibit the reaction, while too high temperatures excessively accelerate the reforming reactions, interfere with the uniform course of the coupled reactions and locally may lead to strong thermal imbalances. This can lead to intensified catalyst aging.

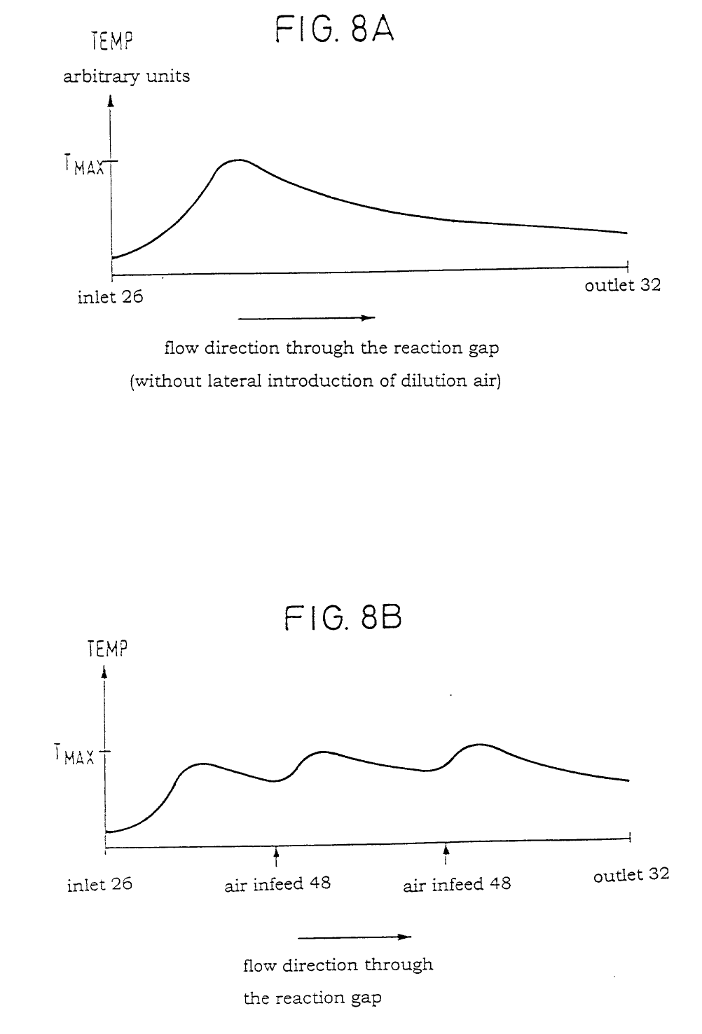

The catalytic oxidation reaction is controlled in the variants described above by introducing air perpendicular to the flow direction of the fuel gas as represented by the arrows 36 in FIGS. 2 and 3. The quantity of air is controlled by the pressure loss of the inlet opening over the length of the reaction gap. The dilution with air reduces the rate of the catalytic reaction; less heat is released and the heat can be selectively managed. By injecting air on the opposite third and fourth sides of 38, 40 of the burner element, one succeeds in metering air over the entire length and width of the catalytic combustion zone, i.e. the reaction gap, in a controlled way. This is explained in more detail below in connection with FIGS. 8A and 8B.

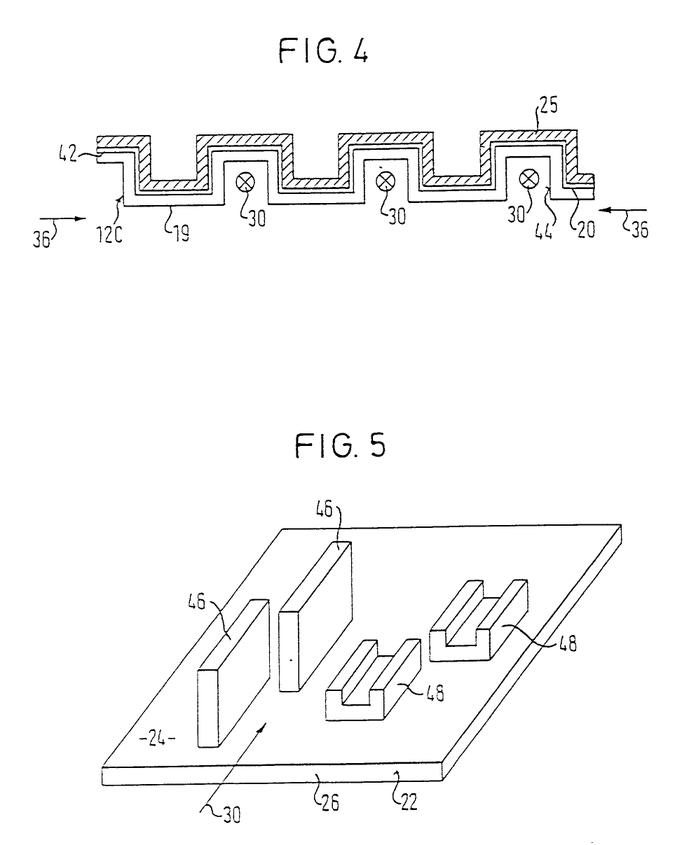

The catalytic combustion zone can exhibit different geometries. One of the possibilities is shown in FIG. 4. The reference number 20 here indicates the upper plate (corresponding to FIG. 3) of the catalytic combustion element 12C of FIG. 1 which forms the boundary surface with the reforming unit 18. Here the plate 20 is designed in a wavelike shape (here with a square waveform, which is also not absolutely necessary). The plate is provided on the bottom side with an oxidation catalyst 19 and on the topside with a reforming catalyst 25. Between the two catalysts 19 and 25, only an extremely thin walled separating layer 42 exists (the plate itself) which is supposed to prevent the passage of gases between the burner element and the reforming unit. This means that the plate 20 is a component both of the burner element 12C and also a component of the reforming unit 18. This has the special advantage that the heat transfer by radiation, conduction and convection takes place directly through the separating layer 42 provided between the oxidation catalyst 19 and the reforming catalyst 25. The circles with crosses in the center represent the arrows 30 shown in FIG. 2 and indicate the direction of flow of the fuel gas/air mixture in the burner element 12C, i.e. perpendicular to the plane of the drawing in FIG. 4, into the drawing. In other words, the square peaks and valleys or grooves 44 formed by the wave shape of the plate 20 are aligned in the direction of flow. Here also diluting air can be introduced in the direction of the arrow 36 from both sides.

FIG. 5 shows the bottom plate 22 of the burner element 12C in FIG. 3 with examples of possible structuring arranged on the topside of the plate, i.e. inside the reaction gap 24. On the left side in FIG. 5, as an example, fin segments 46 are shown which are aligned in the direction of flow 30 and in this example stand perpendicular to the plate 22. On the right side of FIG. 5, channel segments 48 are shown which are also arranged parallel to the flow direction 30.

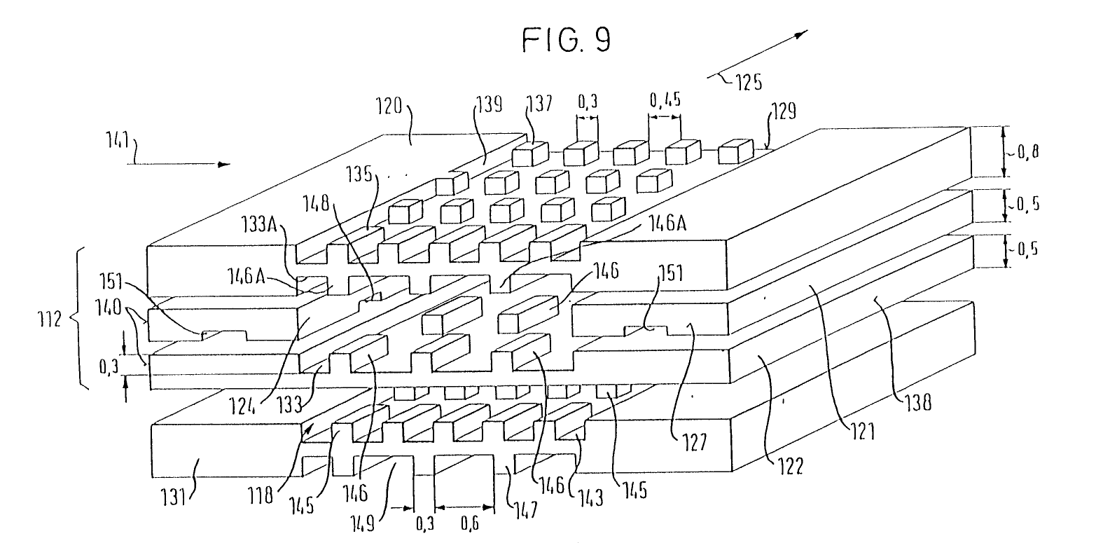

Both the fins 46 and the channels 48 are covered with an oxidation catalyst 19. In this example of embodiment, the corresponding structural features are also provided on the bottom side of the (here not shown) upper plate 20. However, this is not shown for the sake of clarity, since they would only represent an inverted arrangement with respect to FIG. 5. Such a structuring, i.e. on the bottom side of the not-shown upper plate 20, however, is not absolutely necessary, because the bars 46, for example, can bridge the entire reaction gap so that the bottom side of the upper plate can be of planar design. Finally it is also possible to provide different structuring on the bottom side of the plate 22 and on the top side of the (not shown) upper plate 20, e.g. whenever for any reason the heat emission on both sides of the burner element is to be different. The structuring of the bottom side of the plate 22 and the top side of the plate 20, however, is also not absolutely necessary as will be explained in more detail below with reference to FIG. 9.

The catalytic oxidation reaction can take place on such structured surfaces. The structuring, due to its large ratio of surface to volume and the favorable flow mechanics of the geometrical arrangement with flow channels formed in the direction of flow causes a distinct increase in the heat transfer. From this a high efficiency results for heat transfer and therefore a greater catalyst utilization.

Here also a control of the catalytic combustion reaction must be assured. If the structural height of the structuring elements is smaller than the gap height, i.e. the height of the reaction gap, a side air injection must also be performed. If the structuring elements, conversely, fill the entire gap height—which is possible according to the invention—the cross exchange could be prevented.

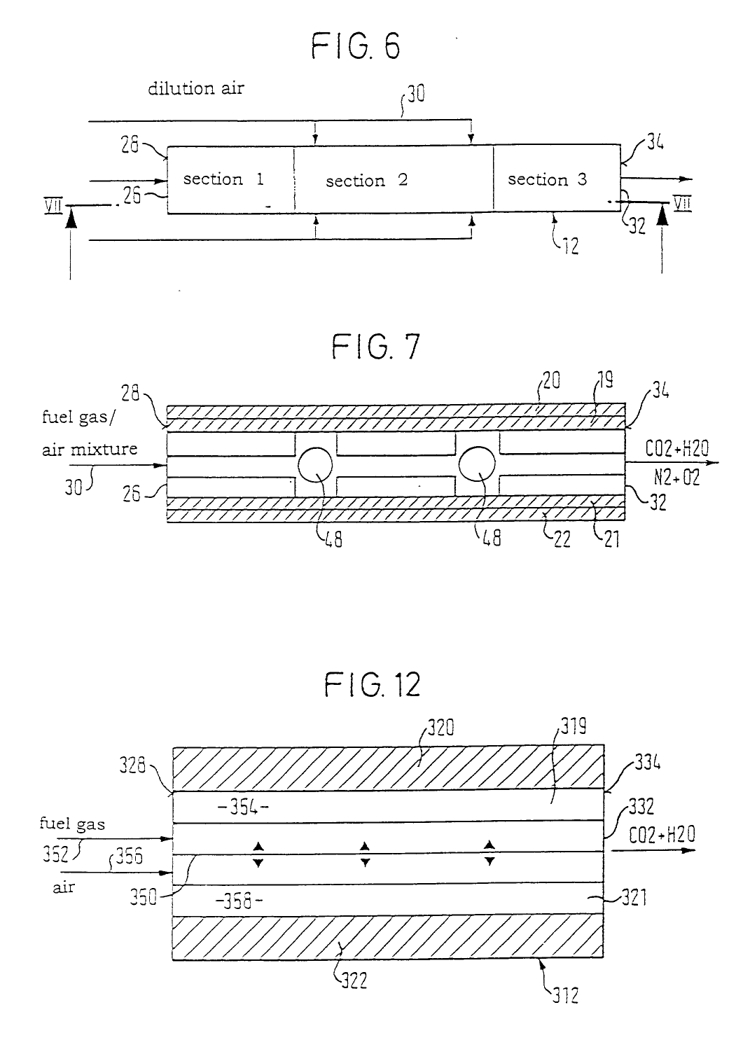

In the case of structuring elements which fill the entire height of the reaction gap, in order nevertheless to achieve a cross flow of diluting air and therefore the desired cross exchange, according to FIGS. 6 and 7, the catalytic combustion zone can be subdivided into several structured sections (section 1, section 2, section 3) which are arranged in each case at a distance from each other, and the diluting air then as before can be injected form the four sides between these partial segments, i.e. in FIGS. 6 and 7 between section 1 and section 2 and between section 2 and section 3 through the corresponding inlet openings 48.

As FIG. 8A shows, the catalytic combustion takes place without the introduction of diluting air from the side so that the temperature increases up to a maximum Tmax which is achieved at a site along the reaction gap which lies at about 25% of the total length of the reaction gap, and after this point the temperature gradually decreases to the outlet 32.

In the arrangement with the side injection of air in two places as shown in FIG. 7 at 48, the temperature in the fuel cell reaches three peaks Tmax which turn out to be somewhat smaller than the peak Tmax shown in FIG. 8A, while the temperature along the reaction gap decreases between neighboring maximum Tmax values by an amount which is clearly smaller than the temperature drop in FIG. 8A. This means that—for the same quantity of the fuel gas/oxygen mixture—a more uniform temperature distribution is achieved over the entire length of the reaction gap, which on the whole is more advantageous for conducting the process than the temperature curve shown in FIG. 8A.

FIG. 9 shows in schematic form how a burner element according to the invention can be constructed from several plate-shaped elements. For this version the same reference numbers are used as before but increased by the base number 100. The description provided for the structural part of the corresponding reference numbers is also valid here for the elements with the corresponding reference numbers.

With reference to FIG. 9, one sees a schematically representative segment from a burner element 112 according to the invention, which consists of three platelike parts, i.e. the upper plate 120, the lower plate 122 and between them a plate-shaped spacer or frame 121. For purposes of representation, the three plates 120, 121, and 122 are pulled apart somewhat so that the internal structure and the structure of the burner element 112 can be understood more easily. It should be emphasized here that this drawing is schematic to the extent that the width of the reaction gap 124, i.e. in the horizontal direction in FIG. 9, is shown substantially shortened. This is also true for the length of the reaction gap 124 of which only a segment is shown in FIG. 9, this length extending in the direction of the arrow 125.

Since only a segment of the burner element is shown in FIG. 9, the front side 127 and the back side 129 cannot be equated with the first side 28 and the second side 34 of FIG. 2, although the front side 127 can be considered as positioned adjacent to the inlet and the side 129 as adjacent to the outlet.

Below the burner element 112 is another plate 131 which belongs to an endothermic process stage of the reforming unit which is supposed to be supplied by the burner element 112 with heat. This plate 131 is shown at a vertical distance away from the plate 122. In a practical variant all plates 120, 121, 122 and 131 lie directly one on the other and are welded together on the outer surfaces so that a sealed-off structure results.

FIG. 9 shows on the lower plate 122 in the center of a depressed region 133, upright bars 146 arranged at regular intervals and in a regular pattern.

The upper plate 120 is also provided with bars 146A arranged in a mirror image whose bottom side in this example is at a distance from the top side of the corresponding bar 146 of the lower plate 122, said distance being determined in this example by the height of the frame plate 121. The bars 146A of the upper plate 120 are arranged according to the arrangement in the bottom plate 122 in a recess 133A of the upper plate 120. Bars 146 and 146A are arranged in rows across the direction of arrow 125 and the rows are in each case offset by half a division with respect to each other.

The example of FIG. 9 shows that the topside of the upper plate 120 also displays structuring elements, here denoted by the reference numbers 135 and 137. The structural elements 135 and 137 are arranged in a recess 139 in the top side of the outer plate 120 so that their top sides in each case are arranged flush with the top side of the plate 120. The bars 135 in this example correspond in size and shape to the bars 146 of the lower plate 122, the bars 137 here are also arranged in rows which, as an example, are square when viewed from the top, and which are arranged offset with respect to each other in the transverse direction, i.e. corresponding to the arrow 141 in FIG. 9.

The structural elements 135 and 137 in the recess 139 belong to the endothermic reaction gap of a processing stage of the fuel processing system which are also supposed to be supplied with heat from the burner element 112 and are also coated with a corresponding catalyst.

While the upper side of the upper plate 120 in FIG. 9 is provided with structural elements, this is not absolutely necessary; the top side of plate 120 can also be of planar design, like the bottom side of the lower plate 122 of the burner element 112. The reaction gap 143 formed between the lower plate 122 and the plate 131 which is designed for carrying out endothermic reactions and receives heat from the burner element 112 for this purpose is therefore defined by the structural elements 145 of the lower plate 131.

Below the plate 131 again structural elements 147 are shown which belong to another reaction gap 149, this reaction gap 149 in turn involving the reaction gap of an (additional) burner element such as 112, i.e. the recess 149 of the bottom plate 131 in this example corresponds to the recess 133A of the upper plate 120.

The reference number 151 in FIG. 9 indicates a feed channel for diluting air, the channels 151 extending in the longitudinal direction of the reaction gap i.e. corresponding to the arrow 125 and open at suitable places 148 (of which only the place on the left side in FIG. 9 is shown) into the reaction gap 124 of the burner element 112 in order to supply diluting air into this reaction gap 124. The possibility of designing the air feed channels 151 and the cross channels forming the opening 148 in one side of the plate shaped spacing frame 121 is very advantageous in practice, because as a result of the small dimensions it would scarcely be possible to create these feeder channels by corresponding borings.

In order to give an idea of the orders of magnitude of the thickness of the plates, the depths of the reaction gaps and the dimensions of the bars as well as their mutual spacing values are entered in FIG. 9 which are to be understood as data in millimeters.

It should be emphasized that FIG. 9 is given only as an example; the exact design of the plates and the structural elements can be selected differently depending on the task. It should be emphasized that the surfaces of all recesses and structural elements are provided with a corresponding catalyst coating which is adapted to the purpose in question.

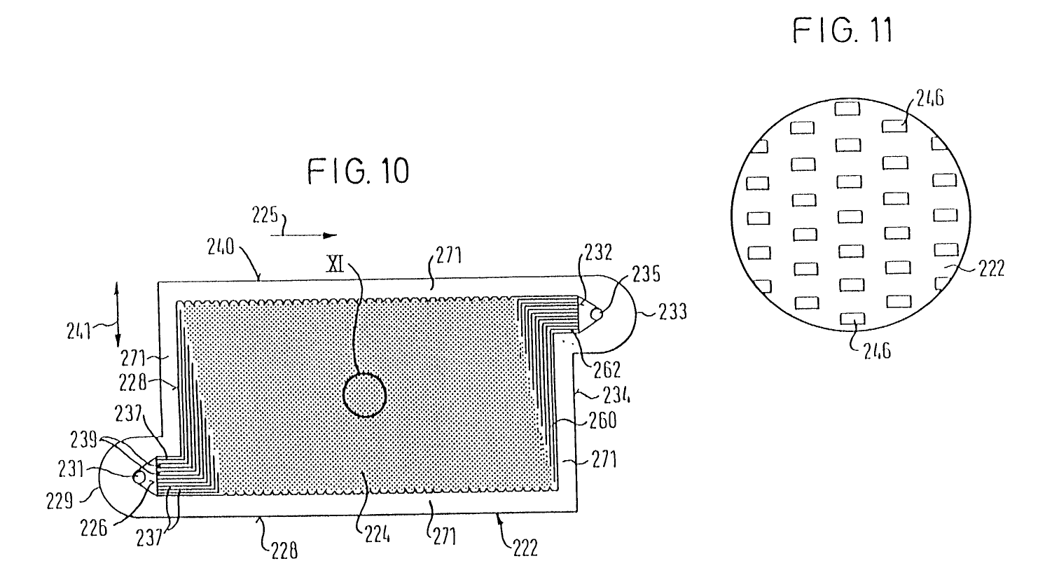

In the examples of embodiment shown in FIGS. 10 and 11, again the same reference numbers are used as for the previous examples, but increased by the base number 200. Here also it is true that the previous description of structural parts with corresponding reference numbers is valid unless otherwise stated.

In the representation of plate 222 in FIGS. 10 and 11, the specific dimensions are also reported in millimeters, i.e. these two drawings are drawn true to scale.

FIGS. 10 and 11 show a top view of a single plate 222 of a burner element according to the invention which here is provided according to the invention with bars, but not with side air feed openings although this would be possible as an option, e.g., either by using the plate in 222 in FIG. 10 with a plate-shaped spacing frame similar to the plate-shaped spacing frame 121 in FIG. 9 by providing corresponding air channels in the edge regions 271 appearing as white regions on the plate shaped elements 222 of FIG. 10. The plate 222 in FIG. 10 is essentially rectangular with first and second opposing sides 228 and 234 respectively and third and fourth opposing sides 238, 240. On the first side 228, an approximately semicircular projection 229 is shown with a boring 231 perpendicular to the plane of the plate 22 which is to be used as a feed channel for a fuel gas/oxygen mixture which is to be passed through the reaction gap 224 formed by the plate 222.

On the second side 234 of the plate 222 is a projection 233 also of semicircular shape, which also displays a vertically arranged boring 235 which in this example forms an exhaust gas channel for the exhaust gases formed in the reaction gap 224.

Adjacent to the feeder channel 231, several metering passages 237 of rectangular cross section in top view are arranged which are separated form each other by corresponding bars 239, also appearing rectangular in top view, which have the function of distributing the fuel gas/oxygen mixture supplied through the feeder channel 231 to different places over the width of the reaction gap 224, i.e. corresponding to the arrow 241, so that a uniform flow occurs along the reaction gap corresponding to the direction of arrow 225 over the entire width of the reaction gap.

In a corresponding manner, on the outlet side 234 of the plate 222, collecting passages 260, also appearing rectangular in top view, are arranged which are formed between bars 262, also appearing rectangular in top view, which have the function of collecting the exhaust gases at the end of the reaction gap 242 and carrying them to the discharge channel 235.

The inlet passages 237 and the collecting passages 260 are arranged in such a way that the distance between the mouth of an inlet passage 237 and the inlet of the opposing collecting passage in each case is always the same.

FIG. 11 shows a 10-fold enlarged representation of the arrangement of the bars 246 in the reaction gap 224 of the plate of FIG. 10. One will note that the bars 246 are arranged in rows which are arranged in the width direction 241 of the plate 222 and that the bars in neighboring rows in each case are offset by half a division with respect to each other.

Another possibility is shown in FIG. 12. It consists of dividing the catalytic combustion zone in two, i.e. the reaction gap shown in FIG. 12. Here also the same reference numbers as before are used, but increased by the base number 300. The division plane 350 here lies between the structured surfaces of the two plates 320, 322 of the burner element 312 and is realized by a separating layer or separating wall 350 with defined openings and defined opening cross sections. Here a separate supply of fuel gas and air is provided, such that fuel gas flows according to arrow 352 in this example into the upper slot like reaction chamber 354 of the burner element 312, and air flows according to arrow 356 into the lower slot like reaction chamber 358 of the burner element 312. Through the openings of the separating layer, a diffusion balancing controlled by pressure losses takes place because the gas flows from the top to the bottom and conversely from the bottom to the top. This mixing-inducing flow arises, because the directed flow above the openings in the separating wall 350 causes turbulence at the openings which assures the desired flows of fuel gas and air into the other chamber in each case. As a result the heterogeneously catalyzed combustion reaction takes place in both of the slot like reaction chambers 354 and 358 of the reaction gap. This type of control is efficiently achieved only if, as provided by the invention, coated catalyst surfaces are used. Otherwise the pellets would plug up the opening cross sections and thus prevent the diffusion equalization. As a result of this variant, a uniform temperature distribution is achieved along the reaction gap and in the transverse direction of the reaction gap.

By means of an appropriate coating technology, structured areas can be defined and coated homogeneously with catalyst. Based on such layers, a fuel processor can be constructed for the generation of fuel gas which is especially compact and operates efficiently.

Within the scope of the present invention, the layer of catalytic combustion merits particular attention. The concept described above offers the following advantages:

efficient heat balancing due to the high surface of the structured layers by radiation, convection and conduction,

avoidance of mass transfer inhibition by switching from catalyst pellets to applied catalyst layers,

greater catalyst utilization and therefore lower catalyst mass small structural volume and weight, and

control of the endothermic reformation reaction by a controlled air supply to the zone of catalytic combustion.

1. A heat-emitting burner element for use with at least one processing device of a fuel cell system performing an endothermic process, e.g., with an endothermic stage of a reforming unit where the burner element consists of at least two plates arranged essentially parallel to each other and at a distance from each other, characterized by the fact that the plates form a reaction gap between themselves and, as a result of the catalytic combustion of a fuel gas/oxygen mixture there on a catalytic coating provided on at least one of the plates and facing the reaction gap, generate heat and emit it by radiation, convection and conduction directly through the coated plate(s) to at least one neighboring endothermic stage and that at least one of the plates displays structural elements also having a catalytic coating and extending into the reaction gap, which runs in the flow direction, which structural elements are if necessary in rows arranged transversely to the direction of flow and offset with respect to each other and consisting, for example, of fins or bars.

2. A burner element as in claim 1, characterized by the fact that the element is essentially four-sided in top view, e.g., square, rectangular or trapezoidal, that the reaction gap displays an inlet and an outlet on the first and second opposite sides of the four-sided element so that the fuel gas/oxygen mixture flows in a flow direction from the inlet on the first side to the outlet on the second side.

3. A burner element as in claim 1 characterized by the fact that the plates forming the reaction gap are of wavelike shape, with the peaks and valleys forming the longitudinal direction of the wave form extending in the flow direction of the fuel gases.

4. A burner element as in claim 3 characterized by the fact that the waveform is a rectangular or square wave.

5. A burner element as in claim 2 characterized by the fact that a device for introducing diluting air transversely to the direction of flow is provided at least in one and preferably in several places along at least one of the also oppositely positioned third and fourth sides of the element.

6. A burner element as in claim 5 characterized by the fact that the device is designed for introducing diluting air in order to introduce it perpendicular to the flow direction of the combustion gases through the reaction gap.

7. A burner element as in claim 5 characterized by the fact that the catalytic combustion chamber defined by the reaction gap is subdivided in the flow direction into several structured sections with the device for introducing diluting air having air openings which in each case are arranged between the neighboring sections following one another.

8. A burner element as in claim 7 characterized by the fact that between two neighboring consecutive sections in each case a distance is provided in the region of the air openings which is at least essentially free of structural elements.

9. A burner element as in claim 8 characterized by the fact that the structured sections display structural elements which bridge the reaction gap between the plates at least essentially completely.

10. A burner element as in claim 7 characterized by the fact that between the two above-mentioned plates on their edge regions, spacers are provided in which or between which the above noted air openings are provided.

11. A burner element as in claim 1 characterized by the fact that the two above-noted plates form on their surfaces facing away from each other a part of an endothermic stage or a reforming unit.

12. A burner element as in claim 11 characterized by the fact that the above-noted surfaces of the plates facing away from each other are also structured and may be coated with a catalyst also.

13. A burner element as in claim 2 characterized by the fact that the inlet communicates with a feed channel for the fuel/oxygen mixture arranged in an edge region on the first side of the element and extending perpendicular to the reaction gap.

14. A burner element as in claim 13 characterized by the fact that the outlet communicates with an outflow channel arranged on the second side of the rectangular element and extending perpendicular to the reaction gap.

15. A burner element as in claim 2 characterized by the fact that the inlet communicates with several feed-in passages which guide the fuel/oxygen mixture to different places in the reactor gap along the first side and thus assure a uniform distribution of the fuel/oxygen mixture over the width of the reactor gap.

16. A burner element as in claim 15 characterized by the fact that the outlet communicates with several collecting passages which collect the exhaust gases from the reactor or the reaction gap at various places along the second side and feed it to the outflow channel.

17. A burner element as in claim 15 characterized by the fact that the feeder passages and the collecting passages are rectangular in each case and are arranged side by side, that the distance in each case between the mouth of one of the feeder passages and the inlet to the collecting passage lying opposite it is always the same.

18. A burner element as in claim 11 characterized by the fact that the two plates together with the other plate-shaped elements of the fuel processing system of the reformer unit are stacked into a stack and the plates or the other plate-shaped elements are welded together on their four sides to form the stack.

19. A burner element as in claim 7 characterized by the fact that the combustion chamber is subdivided into three structured sections and that on at least one of the opposing third and fourth sides two openings are provided for introduction of air.

20. A heat-emitting burner element for use with at least one processing device conducting an endothermic process of a fuel cell system, e.g., with an endothermic stage of a reformer unit, where the burner element consists of at least two essentially parallel spaced-apart plates characterized by the fact that the plates form between themselves a reaction gap and, as a result o the catalytic combustion of a fuel gas/oxygen mixture there on a catalytic coating on at least one of the plates facing the reaction gap, generate heat and emit it by radiation, convection and conduction directly through the coated plate(s) to at least one neighboring endothermic stage, that the element is essentially four-sided at least in top view, e.g., square, rectangular or trapezoidal, that the reaction gap is divided by at least one separating wall into at least two slot-like reaction chambers running parallel to each other and that the one reaction chamber displays on a first side of the four-sided element an inlet for the one component of the fuel gas/oxygen mixture while the second reaction chamber on the same side displays an inlet for another component of the fuel gas/oxygen mixture, the openings being provided and designed in the separating wall(s) in order to make an exchange of gases possible in the reaction chambers or a diffusion equalization, while the gases flow from the inlet to an outlet on second side lying opposite the first side.

21. A burner element as in claim 20 characterized by the fact that the fuel gas is preferably introduced into the first slot-like reaction chamber and air is preferably introduced into the second slot-like reaction chamber.

22. A burner element as in claim 21 characterized by the fact that at least one of the plates displays structural elements also having a catalytic coating and extending into the reaction gap and which extend in the direction of flow and consist, for example, of fins or bars.

23. A burner element as in claim 22 characterized by the fact that the plates forming the reaction gap are of wavelike design, with the peaks and valleys forming the wave form in the longitudinal direction extending in the direction of flow of the fuel gases.

24. A catalyst-coated plate for a heat-emitting burner element which consists of two at least essentially parallel plates arranged at a distance from each other characterized by the fact that the plate in top view is at least essentially four-sided, e.g., square, rectangular or trapezoidal, that on the first and second opposing sides of the four-sided element in each case an inlet region and an outlet region are provided and that the plate displays on the above noted catalyst-covered surface structural elements extending in the direction of flow which elements consist, for example of fins or bars.

25. A plate as in claim 24 characterized by the fact that a device for introducing diluting air transversely to the direction of flow is provided at least in one and preferably in several places along at least one of the opposing third and four sides of the plate.

26. A plate as in claim 24 characterized by the fact that the structural elements are arranged in at least two groups at a distance from each other.

27. A plate as in claim 26 characterized by the fact an air intake site is provided in the spacing region between the groups.

28. A process for controlling the endothermic reforming reactions in a fuel processing system generating a hydrogen-rich synthetic gas which contains at least one burner element in which a fuel/oxygen mixture is introduced into a slot-like reaction chamber, characterized by the fact that control is accomplished at least partially by introducing diluting air into the reaction chamber.

29. A process as in claim 28 characterized by the fact that the control is accomplished by varying the quantity of diluting air fed in.

30. A process for controlling the endothermic reformation reaction in a fuel processing system generating a hydrogen-rich synthetic gas which contains at least one burner element in which the components of the fuel-oxygen mixture are introduced into slot-like reaction chambers separated by a perforated separating wall and adjacent to one another, characterized by the fact that the control is accomplished by varying the total quantity of the constituents supplied.
